(19) United States
(12) Patent Application Publication
(10) Pub. No.: US 2025/0249714 A1
(43) Pub. Date: Aug. 7, 2025

(54) PLUG-IN CHARGING FOR ELECTRIC VEHICLE AND TOWED ELECTRIC TRAILER

(71) Applicant: FORD GLOBAL TECHNOLOGIES, LLC, DEARBORN, MI (US)

(72) Inventors: Mahmoud Yousef Ghannam, Canton, MI (US); Aed M. Dudar, Canton, MI (US); Scott A. Watkins, Canton, MI (US)

(21) Appl. No.: 18/433,851

(22) Filed: Feb. 6, 2024

(51) Int. Cl. B60D 1/62; B60L 53/16; B60L 53/57; B60L 53/65; B60Q 1/30

(52) U.S. Cl. CPC B60D 1/62; B60L 53/16; B60L 53/57; B60L 53/65; B60Q 1/305; B60L 2200/36; B60L 2250/12

(57) ABSTRACT

A towing vehicle and the trailer include respective batteries and electric powertrain for propulsion. A connector system connects the vehicle and trailer via a plurality of conductors, a plug, and a socket including at least seven connector pins. Due to the wire gauge, each conductor carries no more than 20 amps. When a driving state is detected, a first switch matrix in the vehicle and a second switch matrix in the trailer enter a first configuration to connect a plurality of light sources in the trailer to a lighting signal generator in the vehicle. When a charging state is detected, a second configuration of the switch matrices is entered in order to carry a charging current which is divided in parallel among a plurality of conductors in the connector system and then recombined in order to provide a charging current greater than 20 amps.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to electrified trailers to be hauled by electrified passenger vehicles, and, more specifically, to electrical coupling between such trailers and vehicles.

The battery capacity conventionally available on electrified vehicles (EVs) has led to challenges in providing sufficiently long driving distances (i.e., driving range) before needing to be recharged. In addition to providing adequate driving range, it is desirable that when an electric vehicle is recharged that the time required to reach a desired state of charge be kept short.

Improvements in electrified vehicles have enabled them to be employed in many types of vehicle usage applications, including the towing of trailers for expanded cargo capacity or for camping. The accompanying increase in weight means the electric traction motor will need to work harder to haul the trailer, resulting in more power drain and battery depletion (and consequently more down time for plugging into a charger to replenish the battery pack). On average, hauling a trailer may reduce the driving range of an EV by about 50%.

To help alleviate the loss of driving range, a trailer may be electrified itself. For example, an electrified trailer (ET) may carry a battery or battery pack together with a drive (i.e., propulsion) system including an electric traction motor which is activated during driving to propel the ET and to reduce the load requirements for the EV. The high-capacity battery and electric drive motor in the trailer can also be used to reduce the burden caused by pulling a travel trailer for an internal combustion engine (ICE) vehicle.

When an EV is operating together with an ET, the need arises for charging the two respective battery systems. Whether they are public or private, most charging stations are designed for accommodating a single vehicle rather than for a towed arrangement. If a single charger is used to charge the vehicle and the trailer separately, then an undesirably long cable may be needed to plug it in to one for a first period of time and then switch the cable over to the other for a second period of time without moving the vehicle/trailer combination. Otherwise, a driver may be required to perform difficult maneuvers to park and re-park the coupled vehicle and trailer in different positions for charging cable access to the vehicle and trailer in succession.

Some trailers have been proposed for which the main purpose is to carry a supplemental battery which is connected to the battery system of claim main electrified vehicle to extend the driving range. In this case, cables designed to carry high voltage and current levels is used between the supplemental battery and the main vehicle. With high capacity cabling in place, charging may be simplified since charging current can be shared from one of the vehicle or trailer (which is connected to a charger) to the other one (which is not). Such a charging scenario, however, requires not only the high capacity cabling but also the corresponding functional components and programming that make such a sharing of charging current possible. Therefore, the problem remains for EVs which are not specially adapted to share high levels of current with a trailer.

EVs, such as electrified trucks, sport utility vehicles, and recreational vehicles, may typically include conventional trailer wiring for operating signaling lights (such as brake lights, turn signals, and auxiliary lights), controlling auxiliary braking systems in a trailer from the main braking system, or providing a communication bus (e.g., CAN bus) to link trailer electronics with the towing vehicle. As used herein, a signaling-based trailer connector refers to a vehicle-to-trailer interface (such as defined in standards including SAE J2863, SAE J560, ISO 1724, and ISO 11446) configured for use with voltages not greater than 24V. Common examples of the connectors include Pollak-style plugs and sockets and Bargman-style connectors. Wiring sizes used with signaling-based trailer connectors typically ranges from 16 gauge to 12 gauge, which is much smaller than wire sizes utilized for sharing battery charge to provide propulsion or for recharging a battery. For example, individual conductors in typical signaling-based trailer connectors may be limited to about 20 amps, while Level 2 charging of electrified vehicles (the most commonly installed type of EV battery charger) supports currents up to 80 amps.

### SUMMARY OF THE INVENTION

In one aspect of the invention, an apparatus is provided for interconnecting a towing vehicle and a trailer. The towing vehicle and the trailer each include a respective battery and a respective electric powertrain for propulsion during a driving state. The apparatus comprises a first switch matrix in the towing vehicle and a second switch matrix in the trailer. A connector system comprises a plurality of conductors, a plug, and a socket, wherein at least seven connector pins in the plug and socket interconnect the first and second switch matrices via the plurality of conductors. A controller is configured to invoke a first connection state within the first and second switch matrices during the driving state so that lighting signals from the towing vehicle are coupled via the connector system to signaling lights on the trailer. The controller is configured to invoke a second connection state within the first and second switch matrices when the towing vehicle and the trailer are not in the driving state so that a current adapted for charging one of the respective batteries is carried in parallel over at least two of the plurality of conductors.

### BRIEF DESCRIPTION OF THE DRAWINGS

FIG. 1 is a schematic view of an electrified vehicle towing a serial arrangement of two trailers carrying secondary battery units.

FIG. 2 is a schematic view of an electrified trailer coupled by a small gauge trailer lighting plug to an electrified vehicle.

FIG. 3 is an overhead view of a charging station layout having pull-through lanes to accommodate longer vehicles.

FIG. 4 is a schematic view of trailer plug and socket wiring which interconnects switching circuits of an electrified trailer and electrified vehicle.

FIG. 5 is a wiring diagram showing a reassignment of individual wires while in a charging mode.

FIG. 6 is a block diagram showing an electrified trailer and electrified vehicle in greater detail.

FIG. 7 is a flowchart showing one preferred method of the invention.

### DETAILED DESCRIPTION OF PREFERRED EMBODIMENTS

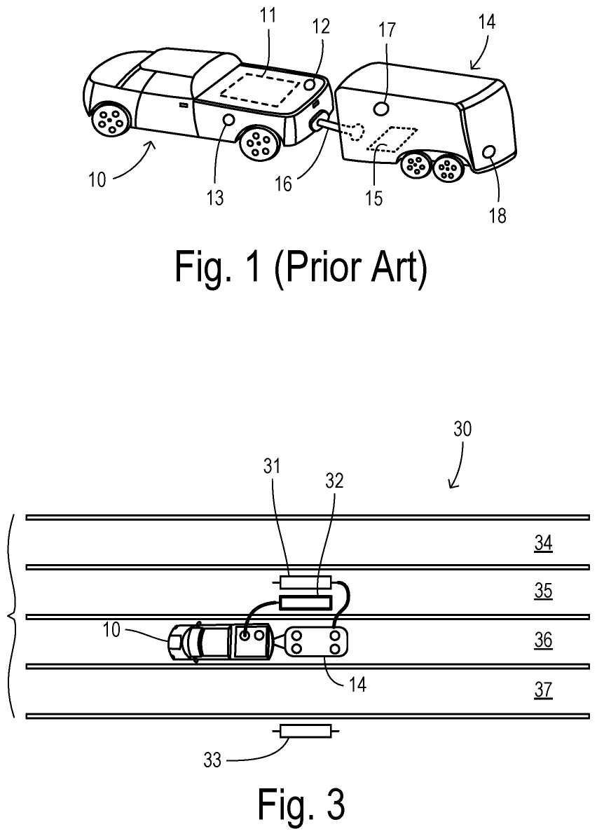

FIG. 1 shows an electrified vehicle 10 (which may be a battery-electric vehicle, or BEV, or a hybrid gas-electric vehicle) which is configured as an electric pickup truck. Vehicle 10 has an onboard rechargeable battery unit 11 which stores electrical power for a traction motor (not shown) to propel vehicle 10. The traction motor may comprise an electric machine mechanically coupled to a gearbox which may include a differential. The electric machine may also act as a generator during deceleration to recover energy that would normally be lost as heat in a friction braking system.

Battery unit 11 may be comprised of a multiple cells to provide a high-voltage, direct current (DC) output. A contactor module may selectably connect battery unit 11 with a high-voltage bus (not shown). A power electronics module (not shown) controls operation of the electric machine and provides the ability to bi-directionally transfer energy between battery unit 11 and the electric machine. The power electronics module may convert the DC voltage to a three-phase AC current to operate the electric machine. In a regenerative mode, the power electronics module may convert the three-phase AC current from the electric machine acting as a generator to a DC voltage for recharging battery unit 11.

Vehicle 10 is configured to recharge battery unit 11 from external power sources (i.e., battery chargers) using one or more charge ports 12 and 13. External power sources may include electrical outlets at private or public locations. Electric vehicle supply equipment (EVSE) for connecting to a vehicle's charging port may include a charger unit at a charging station (i.e., a location having parking stalls or spaces each provided with one or more charger units). A charging station serving a plurality of electrified cars and trucks may be connected to an electrical power distribution network or grid as provided by an electric utility company and may be managed by electronic control systems enabling users to reserve a time period and charger outlet for their use, as described in patent application publication US 2020/0148068A1 and in U.S. Pat. No. 11,001,161, which are both incorporated herein by reference.

Trailer 14 is an electrified trailer having a battery unit 15 and an electric machine (not shown) for independently propelling trailer 14 to match the forward or backward propulsion of vehicle 10, so that the presence of trailer 14 does not prematurely result in depletion of a State of Charge (SOC) of battery unit 11 in vehicle 10. Trailer 14 may include one or more charging ports 17 and 18 which are configured to deliver charging currents from an external battery charger to recharge battery unit 15. A trailer hitch system 16 couples vehicle 10 and trailer 14 in a towing arrangement including mechanical linkage and electrical connections. In particular, trailer hitch system 16 may be of a type intended for providing electrical coupling for conventional trailer functions of operating trailer signal lighting (e.g., stop lights, turn signals, or running lights), transferring control signals to trailer mounted brakes, coupling supplementary DC voltage at low current for other trailer accessories, or transmitting electronic bus communication signals. Moreover, trailer hitch system 16 may lack any wiring or other components to support transfer of battery charging currents between vehicle 10 and trailer 14. Thus, battery unit 11 can only be recharged using charges ports 12 and 13 located on vehicle 10, and battery unit 15 can only be recharged using charges ports 17 and 18 located on trailer 14.

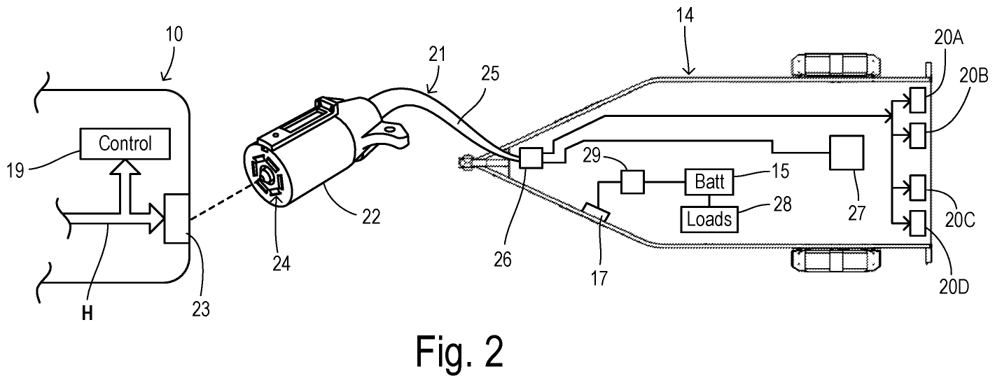

FIG. 2 shows vehicle 10 and trailer 14 in greater detail. A connector system 21 electrically couples towing vehicle 10 and electrified trailer 14. A signaling-based trailer connector includes a plug 22 carried by trailer 14 and a socket 23 mounted on vehicle 10. A plurality of pin arrangements 24 and a plurality of conductors 25 convey electrical signals and have a configuration (e.g., wire size and material) that supports lighting and communication signals having currents up to about 20 amps. A breakout 26 directs electrical signals over other trailer wiring to a plurality of light sources 20A-20D and a trailer brake unit 27. On the vehicle side, a wiring harness H connects to socket 23 to a control module 19 and other vehicle electronics as known in the art. Control module 19 may generate the voltage/current needed from driving light sources 20A-20D or a separate driver can be utilized. In embodiments of the invention described below, a power manager/voltage controller may be further connected to harness H and socket 23 for battery charging.

In FIG. 2, trailer 14 is of a known type which includes self-contained propulsion wherein power from battery 15 is applied to electrical loads 28. Loads 28 may include a traction motor, an inverter, and a motor controller for propelling trailer 14 to follow the movement of vehicle 10. A power manager 29 is coupled between charge port 17 and battery unit 15 to perform conventional charging when connected to an external battery charger.

FIG. 3 shows a pull-through layout of a charging station 30 having charging outlets 31-33 deployed adjacent a plurality of pull-through lanes 34-37. In a charging station with such a layout, the combination of vehicle 10 and trailer 14 can be parked so that towing vehicle 10 and trailer 14 can be recharged simultaneously by connecting them to separate chargers 31 and 32, for example. However, such a pull-through arrangement may be rare for public stations. In addition, the availability of multiple chargers and charger placement (or length of power cables) for reaching both a vehicle and trailer at the same time may be very unlikely at residential installations. It would be desirable to recharge both a towing vehicle and an electrified trailer while remaining at a single parking location and using only a single charger/cable pulling into a single charging port of the combined vehicle and trailer.

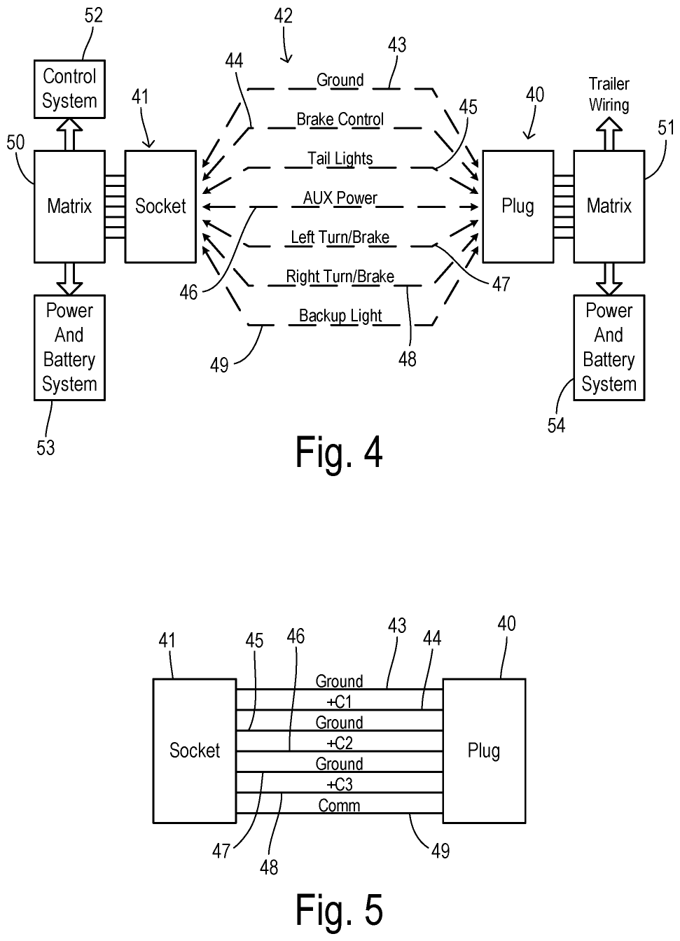

FIG. 4 is a schematic view of an embodiment of the present invention wherein a standard signaling-based trailer connector having a plug 40 and a socket 41. In a common 7-wire arrangement, the pins and wiring conductors associated with plug 40 and socket 41 define a plurality of conductor paths 42 including a ground wire 43, a brake control wire 44, a taillight wire 45, an auxiliary power wire 46, a left turn/brake light wire 47, a right turn/brake light wire 48, and a backup light wire 49. A switch matrix 50 in the vehicle and a switch matrix 51 in the trailer are connected to socket 41 and plug 40, respectively, in order to employ conductor paths 42 according to dual purposes of (1) the normal driving operation during a driving state, and (2) providing multiple parallel current paths for distributing a charging current into smaller current portions for enabling the transfer of a total charging current greater than the individual rating of any of the conductor paths in the trailer connector. Matrix 50 and matrix 51 may preferably be comprised of electronically-controller relay switches, for example. In a first connection state of matrices 50 and 51 which is selected in the driving state, individual switches in the matrices interconnect lighting signals from a control system 52 in the towing vehicle to conventional trailer wiring leading to signaling lights on the trailer. In a second connection state of matrices 50 and 51 invoked during a battery charging state, the individual relay switches interconnect conductor paths 42 to a power and battery system 53 in the vehicle and a power and battery system 54 in the trailer so that a current adapted for charging one of the respective batteries is carried in parallel over at least two of the plurality of conductor wires 43-49.

FIG. 5 shows one example of a reassignment of conductor wires according to pairings of wires to each conduct a respective current portion through the connection system which can then be recombined in the power/battery system of the receiving one of the vehicle or trailer. Depending on the relative sizes of the actual wire gauges available, one or more wires may be provided for carrying a positive side of a respective portion of the current while one or more wires may be provided for carrying the ground side of that respective portion of the current. FIG. 5 shows a one to one correspondence of wires in each portion of the current. Thus, wires 43 and 44 carry a first portion C1 of the current, wires 45 and 46 carry a second portion C2 of the current, and wires 47 and 48 carry a third portion C3 of the current. If, for example, each of current portions C1, C2, and C3 were limited by the wire gauge sizes to 20 amps each, then the current portions can be recombined at a receiving end to provide a battery charging current of up to 60 amps.

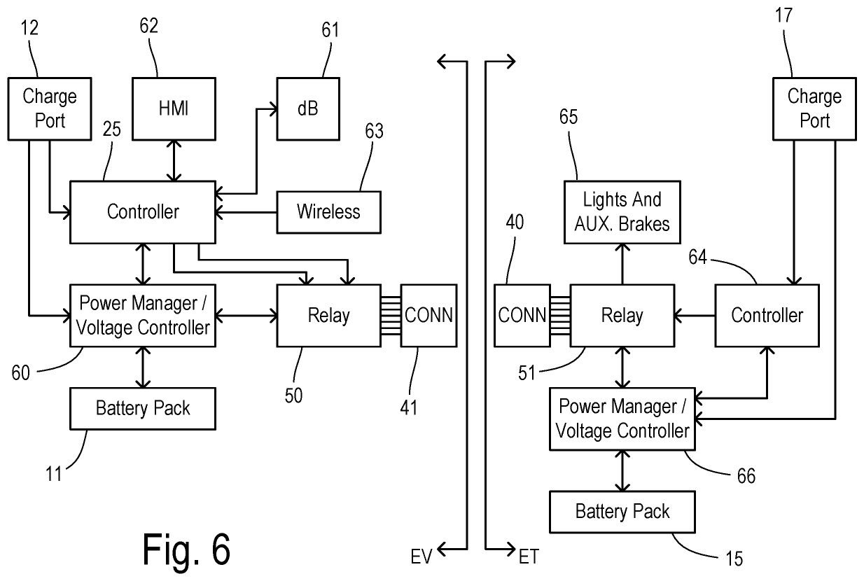

FIG. 6 shows an embodiment of the invention with an electrified vehicle side EV and an electrified trailer side ET. Connectors 40 and 41 of a connector system interconnect the vehicle and trailer between switch matrices 50 and 51. Matrices 50 and 51 are shown as relays which couple a plurality of conductors through the respective connectors to carry either a set of driving signals (during a driving state) or a set of charging signals (during a battery charging state). On the EV side, relay 50 is connected to power manager/voltage controller 60 which interfaces with a battery pack 11 and a charge port 12. A controller 25 is connected to power manager/voltage controller 60 and to charge port 12 to operate charging functions in a known manner. Controller 25 is coupled to relay 50 to select between configurations of individual switches in relay 50 to couple connector 41 to either sources of light signaling/trailer breaking signals during the driving state or battery charging signals (either to or from the vehicle) during a charging state. Controller 25 is further connected to a memory 61 having a specification database for identifying wire gauge sizes according to an identification or classification of a particular trailer which is present. An identification may be made according to identification signals sent from the trailer to controller 25 via the connector system or according to other means of identification (e.g., capturing an image of the trailer for analysis or by manual input from a user of the vehicle). For manual input, a human machine interface (HMI) 62 is provided. Alternatively, user input may be obtained via a wireless connection via a wireless transceiver 63 for communicating with a mobile device carried by the user. HMI 62 and/or a mobile app on the mobile device may further provide an interface for specifying charging parameters for the distribution of charging currents when in the charging mode as described below.

Controller 25 is coupled to relay 50 to select between first or second switch configurations as well as to supply vehicle lighting signals when in the driving state. Controller 25 interfaces with power manager/voltage controller 60 in order to appropriately configure respective portions of a charging current during the charging state and to distribute the portions of current to respective inputs of relay 50 so that the current portions is coupled in parallel to different conductors of the connector system. The parallel currents can then be recombined in the trailer after being directed via relay 51 to a power manager/controller 66 in the trailer.

The trailer further includes a controller 64 for controlling operation of power manager/voltage controller 66 as well as selecting between the first and second configurations of relay 51 (i.e., to direct signals between the connector system and either light sources and auxiliary braking units 65 or power manager/voltage controller 66. Charge port 17 on the trailer side is likewise coupled to controller 64 and power manager/voltage controller 66, wherein controller 64 can detect a charging state at the trailer side and can initiate transfer of charging signals via the connector system to the vehicle.

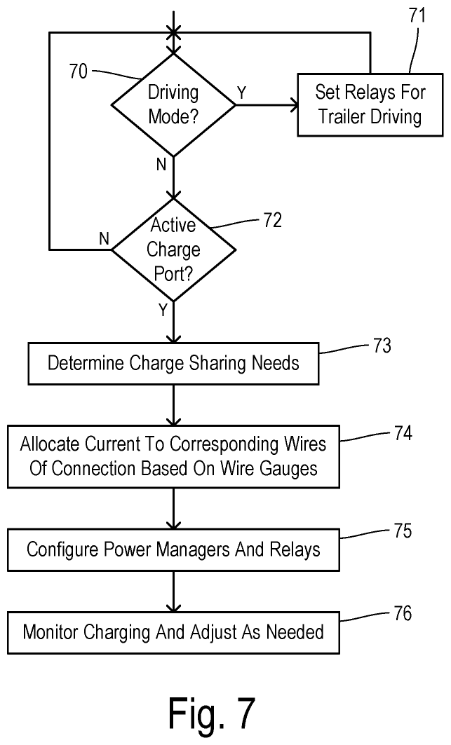

FIG. 7 shows one preferred method of the invention wherein a check is performed in step 70 to determine whether the vehicle/trailer are in a driving mode. Driving mode may be triggered when a vehicle drivetrain is activated, when a vehicle is in gear, or in response to any other vehicle status which is not consistent with vehicle charging. When the driving mode is detected, the relays are set for trailer driving in step 71. The configuration of the relays connects a lighting signal generator in the vehicle to light sources in the trailer (i.e., each of the conductors in the connector system function according to their standard trailer signaling and/or braking functions). When not in driving mode, a check is performed in step 72 to determine whether the vehicle/trailer are in a charging mode. The charging mode may be detected when a charge port becomes active, for example. If charging mode is not detected, then a return is made to step 70 for further monitoring.

When a charge port is active in step 72, then a determination is made in step 73 of any charge sharing needs between the battery units of the vehicle and trailer (e.g., whether one or both batteries need charging). Preferably, a user may be given an ability to determine various charging parameters such as specifying an order of charging (either the vehicle or the trailer first) or specifying target charging levels for at least one of the battery units. The user may choose to have both batteries charge simultaneously. A user may instead specify initially charging one of the battery units to an initial target level, subsequently charging the other battery unit to another target level, and then returning to charge the first battery unit to yet another target level (e.g., fully charged).

Based on the selected charge sharing and on the corresponding wire gauge sizes present in the connector system, current portions are allocated among corresponding wires of the connector system in step 74. In step 75, the power managers and relays are configured according to the current allocations from step 74. After configuring the relays and power managers, a charge current is obtained from the charge port and distributed according to the allocations. The current flow and charge levels are monitored in step 76, and the current flows are adjusted as needed when various target levels are reached.

What is claimed is:

1. Apparatus interconnecting a towing vehicle and a trailer, wherein the towing vehicle and the trailer each include a respective battery and a respective electric powertrain for propulsion during a driving state, the apparatus comprising:
a first switch matrix in the towing vehicle;
a second switch matrix in the trailer; and
a connector system comprising a plurality of conductors, a plug, and a socket, wherein at least seven connector pins in the plug and socket interconnect the first and second switch matrices via the plurality of conductors;
a controller configured to invoke a first connection state within the first and second switch matrices during the driving state so that lighting signals from the towing vehicle are coupled via the connector system to signaling lights on the trailer, and configured to invoke a second connection state within the first and second switch matrices when the towing vehicle and the trailer are not in the driving state so that a current adapted for charging one of the respective batteries is carried in parallel over at least two of the plurality of conductors.

2. The apparatus of claim 1 further comprising a current regulator configured to direct a plurality of parallel currents to respective ones of the plurality of conductors, wherein each respective parallel current is limited within a respective predetermined maximum current capacity of each respective conductor according to its respective wire gauge.

3. The apparatus of claim 2 wherein the controller is configured to (1) determine an identification at least one of the towing vehicle or the trailer, and (2) obtain the respective predetermined maximum current capacities of the respective conductors in a specification database according to the identification.

4. The apparatus of claim 1 wherein at least one of the towing vehicle and the trailer has a charge port adapted to connect to an external battery charger, and wherein not being in the driving state is detected in response to the charge port being coupled to the external battery charger.

5. The apparatus of claim 1 wherein the battery receiving the current adapted for charging is in one of the towing vehicle or the trailer, and wherein the other one of the towing vehicle or the trailer includes a charge port adapted to connect to an external charger in order to generate the current adapted for charging.

6. The apparatus of claim 1 wherein the controller is responsive to a selection made by a user to specifying a charge sharing between the towing vehicle and the trailer.

7. The apparatus of claim 6 wherein the specified charge sharing includes an order of charging or a target charging level for at least one of the respective batteries in the towing vehicle and the trailer.

8. A method of interconnecting a towing vehicle and a trailer, wherein the towing vehicle and the trailer each include a respective battery and a respective electric powertrain for propulsion, wherein the towing vehicle and the trailer are electrically connected via a connector system comprising a plurality of conductors, a plug, and a socket, wherein the plug and socket include at least seven connector pins, wherein the connector pins and respective conductors are configured to carry no more than 20 amps, the method comprising the steps of:
detecting a driving state of the towing vehicle and trailer;
when in the driving state then configuring a first switch matrix in the towing vehicle and a second switch matrix in the trailer in a first configuration to interconnect the connector system between a plurality of light sources in the trailer to a lighting signal generator in the towing vehicle;
detecting a charging state of the towing vehicle or the trailer; and
when in the charging state then configuring the first switch matrix in the towing vehicle and the second switch matrix in the trailer in a second configuration to carry a current adapted for charging one of the respective batteries in parallel over at least two of the plurality of conductors in the connector system.

9. The method of claim 8 further comprising the step of directing a plurality of respective parallel currents to respective conductors, wherein each respective parallel current is limited to a respective predetermined maximum current capacity of each respective conductor according to its respective wire gauge.

10. The method of claim 9 further comprising the steps of:
determining an identification at least one of the towing vehicle or the trailer; and
obtaining the respective predetermined maximum current capacities of the respective conductors from a specification database according to the identification.

11. The method of claim 8 wherein at least one of the towing vehicle and the trailer has a charge port adapted to connect to an external battery charger, and wherein the charging state is detected in response to the charge port being coupled to the external battery charger.

12. The method of claim 8 wherein the battery receiving the current adapted for charging is in one of the towing vehicle or the trailer, and wherein the other one of the towing vehicle or the trailer includes a charge port adapted to connect to an external charger in order to generate the current adapted for charging.

13. The method of claim 8 further comprising the step of a user specifying a charge sharing between the towing vehicle and the trailer.

14. The method of claim 13 wherein the specified charge sharing includes an order of charging or a target charging level for at least one of the respective batteries in the towing vehicle and the trailer.
